(19) United States
(12) Patent Application Publication
(10) Pub. No.: US 2024/0334025 A1
(43) Pub. Date: Oct. 3, 2024

(54) SYSTEMS AND METHODS FOR SUPPLEMENTAL CONTENT DISTRIBUTION

(71) Applicant: Comcast Cable Communications, LLC, Philadelphia, PA (US)

(72) Inventor: Alexander GILADI, Denver, CO (US)

(21) Appl. No.: 18/625,050

(22) Filed: Apr. 2, 2024

Related U.S. Application Data
(60) Provisional application No. 63/493,875, filed on Apr. 3, 2023.

(51) Int. Cl. H04N 21/81; H04N 21/431; H04N 21/845

(52) U.S. Cl. CPC H04N 21/8126; H04N 21/4316; H04N 21/812; H04N 21/8456

(57) ABSTRACT

Methods and systems for distributing supplemental content are disclosed. A first manifest file associated with a content item may be received via at least one server. Based at least on the first manifest file, a second manifest file may be generated. The second manifest file may comprise data for accessing a plurality of segments of the content item and data for accessing at least one supplemental content item. The second manifest file may be sent to a computing device. The computing device may be configured, based on the second manifest file, to output the at least one supplemental content item during output of at least one of the plurality of segments of the content item.

### CROSS-REFERENCE TO RELATED APPLICATIONS

This application claims the benefit of U.S. provisional Application No. 63/493,875, filed Apr. 3, 2023, which is incorporated by reference in its entirety.

### BACKGROUND

Content may be distributed to users nationwide for viewing. While the same content may be output to all of the users for viewing, it may be desirable for at least a portion of supplemental content output along with the content to differ depending on user location. For example, it may be desirable for users viewing the content in a particular location to also view supplemental content that is relevant to that particular location. Therefore, improvements in supplemental content distribution techniques are desirable.

### SUMMARY

Methods and systems for supplemental content distribution are disclosed. A manifest file may contain both data for accessing one or more segments of a main content item (e.g., television program, sports event, movie, news program, etc.) and data for accessing one or more segments of a supplemental content item (e.g., supplemental content overlay). A client device may receive the manifest file. The client device may use the manifest file to cause synchronized output (e.g., display) of the supplemental content item during output of at least one segment of the content item.

This summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

Additional advantages will be set forth in part in the description which follows or may be learned by practice. It is to be understood that both the foregoing general description and the following detailed description are exemplary and explanatory only and are not restrictive.

### BRIEF DESCRIPTION OF THE DRAWINGS

The accompanying drawings, which are incorporated in and constitute a part of this specification, illustrate embodiments and together with the description, serve to explain the principles of the methods and systems.

FIG. 1 is an example system.

FIG. 2 is an example system.

FIG. 3 is an example manifest file.

FIG. 4 is an example method.

FIG. 5 is an example method.

FIG. 6 is an example computing device.

### DETAILED DESCRIPTION OF ILLUSTRATIVE EMBODIMENTS

Methods and systems for distribution supplemental content are disclosed. Content, such as television programs, sports events, movies, news programs, or other forms of video presentations, may be distributed to users nationwide for viewing. Supplemental content may be output along with (e.g., during output of) the content. The supplemental content may comprise overlays (e.g., graphic overlays). The overlays may comprise local station logos, local station tickers, advertisement banners, sign language tracks, and/or the like. If the supplemental content comprises overlays, the supplemental content may be overlaid (e.g., superimposed) on the content during output of the content.

The supplemental content that is output along with the content may differ depending on location. For example, a national broadcast of a content item may be televised by multiple local (e.g., affiliate) stations. The supplemental content output along with the national broadcast of the content item may differ depending on the local station. Each local station may televise the national broadcast of the content item along with that particular station's logo or ticker, and/or each local station may televise the national broadcast of the content item along with advertisement banners that are targeted to viewers in that region.

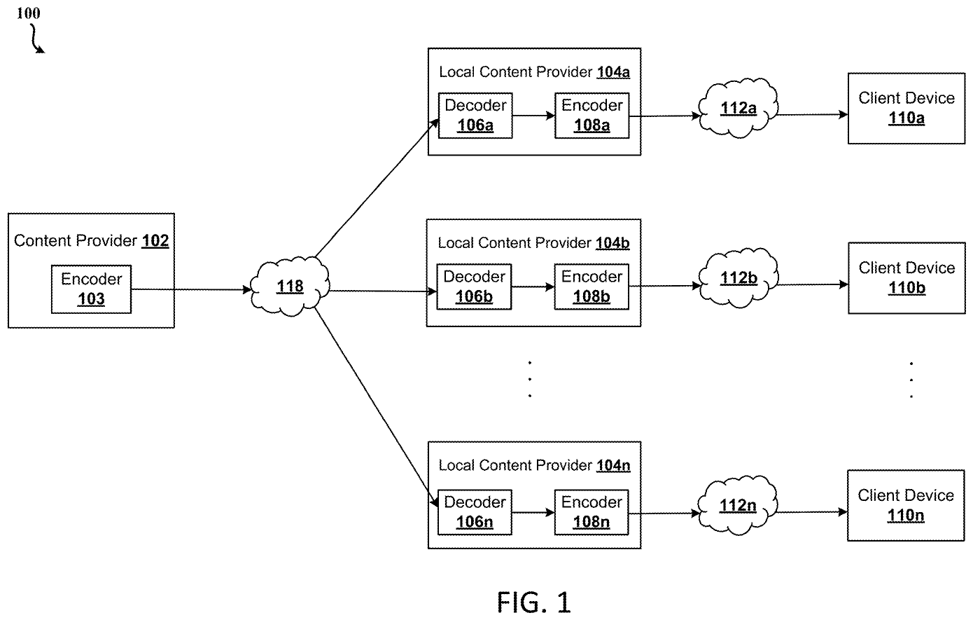

FIG. 1 is an example system 100 for distributing content along with local supplemental content. The system 100 may comprise a content provider 102, a plurality of local content providers 104a-n, and a plurality of client devices 110a-n. The content provider 102 may store content, such as in one or more databases associated with the content provider 102. The plurality of local content providers 104a-n may store supplemental content, such as in one or more databases associated with the plurality of local content providers 104a-n. The content provider 102 and the plurality of local content providers 104a-n may be in communication via a network 118. The plurality of local content providers 104a-n and the plurality of client devices 110a-n may be in communication via a plurality of networks 112a-n.

The content provider 102 (e.g., service provider, entity) may comprise one or more computing devices, network devices, and/or the like. The content provider 102 may distribute (e.g., send) content to the plurality of local content providers 104a-n for distribution to the plurality of client devices 110a-n. The content provider 102 may, for example, comprise a major television network configured to distribute national programming. At least one of the plurality of local content providers 104a-n may comprise a local broadcaster owned by a company other than the content provider 102. At least one of the plurality of local content providers 104a-n may comprise an advertiser. Each of the plurality of local content providers 104a-n may be associated with a particular local geographic region, such as a particular city, state, or region defined by one or more zip codes. The content provider 102 may be associated with any quantity of local content providers in one particular local geographic region.

The content provider 102 may comprise an encoder 103. The encoder 103 may comprise one or more computing devices, network devices, and/or the like. The content provider 102 may be configured to distribute encoded content to each of the plurality of local content providers 104a-n for distribution to the plurality of client devices 110a-n. To distribute encoded content to each of the plurality of local content providers 104a-n, the content provider 102 may encode the content using the encoder 103. The encoder 103 may be configured to encode the content. The encoder 103 may encode a plurality of different versions of the content. Each version of the content may be encoded at a different bitrate. Each version may have other properties that differ from other versions, such as a different compression technique, compression ratio, resolution, frame rate, video quality (for video), number of channels, or sampling rate (for audio). The encoder 103 may send the encoded content, such as one or more of the plurality of different versions of the content, to a requesting component, such as to each of the plurality of local content providers 104a-n.

The plurality of local content providers 104a-n may each comprise one or more computing devices, network devices, and/or the like. The plurality of local content providers 104a-n may be configured to receive the encoded content. Each of the plurality of local content providers 104a-n may comprise a decoder 106a-n. The decoders 106a-n may comprise one or more computing devices, network devices, and/or the like. The local content provider 104a may comprise the decoder 106a, the local content provider 104b may comprise the decoder 106b, and so on. The plurality of local content providers 104a-n may be configured to decode the received encoded content. The plurality of local content providers 104a-n may decode the encoded content using the respective decoder 106a-n. For example, the local content provider 104a may decode the encoded content using the decoder 106a, the local content provider 104b may decode the encoded content using the decoder 106b, and so on.

The plurality of local content providers 104a-n may be configured to insert one or more supplemental content items into the decoded content. The supplemental content item(s) may comprise one or more overlays (e.g., graphic overlays). The overlays may comprise local station logos, local station tickers, advertisement banners, sign language tracks, and/or the like. At least one of the plurality of local content providers 104a-n may be configured to insert different supplemental content item(s) into the decoded content than the remainder of the plurality of local content providers 104a-n. The local content provider 104a may insert different supplemental content item(s) into the decoded content than the local content provider 104b, the local content provider 104b may insert different supplemental content item(s) into the decoded content than the local content provider 104c, and so on.

The supplemental content item(s) inserted by a particular local content provider of the plurality of local content providers 104a-n may be associated with that particular local content provider. For example, the local content provider 104a may insert a station logo and/or a station ticker associated with the local content provider 104a into the decoded content. The local content provider 104b may insert a station logo overlay and/or a station ticker overlay associated with the local content provider 104b into the decoded content. The local content provider 104c may insert a banner advertisement overlay into the decoded content. The banner advertisement overlay may be targeted to viewers in the geographic region serviced by the local content provider 104c. The local content provider 104d may insert a sign language overlay into the decoded content. The sign language overlay be associated with the geographic region serviced by the local content provider 104d. For example, the sign language overlay may be associated with American sign language (ASL) if the local content provider 104d is associated with the United States, and the sign language overlay may be associated with British sign language (ASL) if the local content provider 104d is associated with the United Kingdom, etc.

The plurality of local content providers 104a-n may comprise encoders 108a-n. The encoders 108a-n may comprise one or more computing devices, network devices, and/or the like. The plurality of local content providers 104a-n may be configured to encode the content along with the inserted supplemental content item(s) (e.g., the combined content). Each of the plurality of local content providers 104a-n may comprise an encoder 108a-n. For example, the local content provider 104a may comprise the encoder 108a, the local content provider 104b may comprise the encoder 108b, and so on. The encoders 108a-n may encode a plurality of different versions of the combined content. Each version of the combined content may be encoded at a different bitrate. Each version may have other properties that differ from other versions, such as a different compression technique, compression ratio, resolution, frame rate, video quality (for video), number of channels, or sampling rate (for audio). The encoders 108a-n may send the encoded combined content, such as one or more of the plurality of different versions of the combined content, to a requesting component, such as to the plurality of client devices 110a-n.

The plurality of local content providers 104a-n may be configured to send the encoded combined content to the plurality of client devices 110a-n for output. Each of the plurality of local content providers 104a-n may be configured to distribute the encoded combined content to a subset of the plurality of client devices 110a-n. For example, the local content provider 104a may distribute content received from the content provider 102 to the client device 110a, the local content provider 104b may distribute content received from the content provider 102 to the client device 110b, and so on.

The plurality of client devices 110a-n may receive the encoded combined content. Based on the encoded combined content, the plurality of client devices 110a-n may cause display of the content along with the corresponding supplemental content item(s). The plurality of client devices 110a-n may comprise a decoder. The decoder may decompress/decode the encoded combined content. The plurality of client devices 110a-n may output the decoded combined content. The plurality of client devices 110a-n may comprise a television, a monitor, a laptop, a desktop, a smart phone, a set-top box, a cable modem, a gateway, a tablet, a wearable computing device, a mobile computing device, any computing device configured to receive and/or output (e.g., playback, display) content, and/or any combination of the foregoing. It should be noted that while the singular term device is used herein, it is contemplated that some devices may be implemented as a single device or a plurality of devices (e.g., via load balancing). Any device disclosed herein may be implemented using one or more computing nodes, such as virtual machines, executed on a single device and/or multiple devices.

However, the process of encoding content at the content provider 102, then decoding and re-encoding the content at the plurality of local content providers 104a-n may be costly, time consuming, and/or resource intensive. Instead of performing the encoding, decoding, and re-encoding process described above with regard to FIG. 1, supplemental content may be separated from the main content, and then the supplemental content and the main content may be combined at the client devices. Separating the supplemental content from the main content and then combining the two at the client devices may save significant resources. However, separating the supplemental content from the main content and then combining the two at the client devices may be difficult. Further, the supplemental content may need to be synchronized with the main content. For example, the station logo may need to disappear during advertisement breaks, or a semitransparent ratings box may need to be displayed for some time after the advertisement break.

Several techniques exist that may facilitate the separation of the supplemental content from the main content and the combination of the two at the client devices, though each of these techniques has its downsides. First, timed text markup language (TTML) may be used for overlay carriage. However, client device support for image profile of TTML is far from ubiquitous. The image profile of TTML may require an increased bandwidth, as each change in the overlay (e.g., fade-in and/or fade-out effect) may be transmitted as one or more still pictures (e.g., PNG) rather than as a video. Further, using TTML for overlay carriage may interfere with closed captioning and/or subtitles as multiple layers of TTML overlays may exist. Second, HTML5 with JavaScript code may be used to facilitate the separation of the supplemental content from the main content and the combination of the two at the client devices. However, HTML5 with JavaScript code may not facilitate supplemental content synchronization with the main content. Third, high efficiency video coding (HEVC) tiles may be used to facilitate the separation of the supplemental content from the main content and the combination of the two at the client devices. However, this approach requires hardware support for HEVC tiles, suffers from a lack of transparency, and places multiple restrictions on the encoder. Therefore, improvements in supplemental content distribution techniques are desirable.

Described herein are improved supplemental content distribution techniques. Supplemental content, such as graphic overlays, may be encoded as videos and composed at the client devices. The encoded supplemental content and encoded main content may be carried as a part of a single manifest file (e.g., media presentation description (MPD), m3u8, etc.). Using the same manifest file for both the supplemental content and the main content may ensure synchronization between the supplemental content and the main content during output.

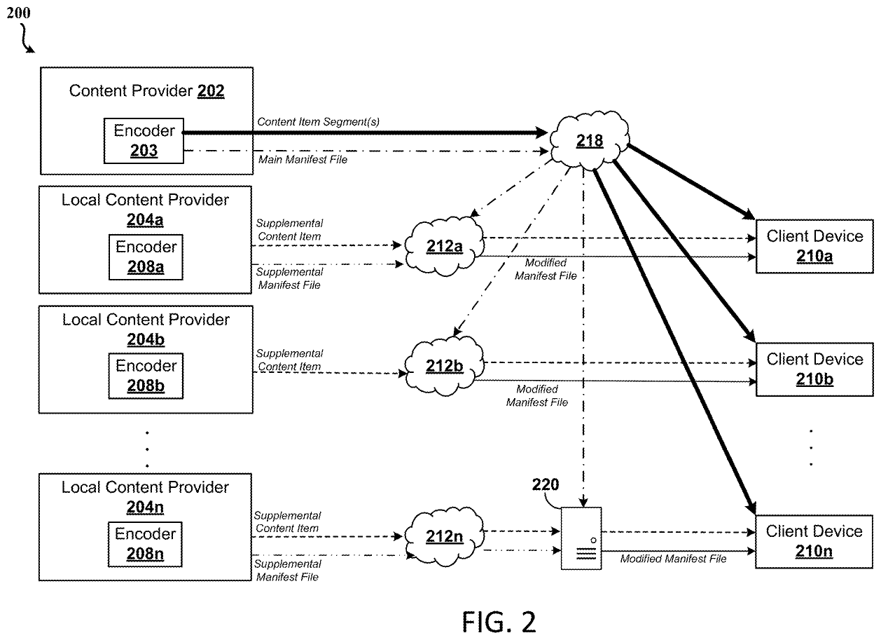

FIG. 2 is an example system 200 for improved supplemental content distribution. The system 200 may comprise a content provider 202, a plurality of local content providers 204a-n, and a plurality of client devices 210a-n. The content provider 202 may, for example, comprise a major television network configured to distribute national programming. At least one of the plurality of local content providers 204a-n may comprise a local broadcaster owned by a company other than the content provider 202. At least one of the plurality of local content providers 204a-n may comprise an advertiser. Each of the plurality of local content providers 204a-n may be associated with a particular local geographic region, such as a particular city, state, or region defined by one or more zip codes. The content provider 202 may be associated with any quantity of local content providers in one particular local geographic region. The content provider 202 and/or each of the plurality of local content providers 204a-n may comprise one or more computing devices, network devices, and/or the like.

The content provider 202 may be associated with and/or in communication with at least one server 218. The plurality of local content providers 204a-n may each be associated with and/or in communication with at least one server 212a-n. For example, the local content provider 204a may be associated with the server(s) 212a, the local content provider 204b may be associated with the server(s) 212b, and so on. The plurality of local content providers 204a-n may be in communication with the server(s) 218. The plurality of client devices 210a-n may be in communication with the server(s) 218 and the server(s) 212a-n.

The content provider 202 may be configured to distribute encoded content to the plurality of client devices 210a-n. To distribute encoded content to the plurality of client devices 210a-n, the content provider 202 may encode the content using an encoder 203. The encoder 203 may be configured to encode the content. The encoder 203 may encode a plurality of different versions of the content. Each version of the content may be encoded at a different bitrate. Each version may have other properties that differ from other versions, such as a different compression technique, compression ratio, resolution, frame rate, video quality (for video), number of channels, or sampling rate (for audio). content provider 202 may be configured to cause the encoded content, such as one or more of the plurality of different versions of the content, to be sent a requesting component, such as to each of the plurality of client devices 210a-n.

The content provider 202 may send a first (e.g., main) manifest file (e.g., MPD, m3u8, etc.) to one or more of the plurality of local content providers 204a-n. The first manifest file may be sent to the plurality of local content providers 204a-n based on (e.g., in response to) a request to receive the content item from the plurality of client devices 210a-n. The content provider 202 may send the first manifest file to the plurality of local content providers 204a-n by sending the first manifest file to the server(s) 218. The server(s) 218 may receive the first manifest file from the content provider 202. The server(s) 218 may send the first manifest file to the plurality of local content providers 204a-n.

The server(s) 218 may send the first manifest file to the local content providers 204a-b by sending the first manifest file to the server(s) 212a-b associated with the local content providers 204a-b. For example, the server(s) 218 may send the first manifest file to the server(s) 212a and to the server(s) 212b. The server(s) 218 may send the first manifest file to the local content providers 204n by sending the first manifest file to an edge server 220. The edge server 220 may be associated with the local content provider 204a. The edge server 220 may be located at a cable modem termination system (CMTS) location. At least one virtualized cable modem termination system (vCMTS) may be executing on the server 220. The vCMTS may be configured to control a plurality of end nodes that modulate signals at a variety of locations to communication with different client devices.

The first manifest file may be associated with a content item (e.g., main content item). The first manifest file may contain information describing various aspects of the content item that may be useful for a user device to output (e.g., playback) the content item and/or for the content provider 202 to store and retrieve the content item. For example, the first manifest file may indicate each of a plurality of content segments associated with the content item, the length of each segment, the number of segments, and/or the proper ordering of the segments necessary to effectuate a playback of the content item. The first manifest file may further indicate a network location (e.g., a hyper-text transfer protocol (HTTP) uniform resource locater (URL) link or other universal resource identifier (URI)) for each segment from which the segment may be downloaded, accessed, or retrieved. It will be appreciated that the network locations included within the first manifest file may point to more than one different location or source. The first manifest file may further indicate available representations of the content item. A representation (e.g., also known as variant in HLS and track in CMAF) may be a single encoding version of content. As a non-limiting example, video encoded with the H.264 codec at bitrate of 4.20 Mbps, resolution of 1080p and frame rate of 59.94 fps may be a representation. Another representation may have a resolution of 780p.

The plurality of local content providers 204a-n may be configured to distribute encoded supplemental content to each of the plurality of client devices 210a-n. The supplemental content may comprise overlays (e.g., graphic overlays), advertisements, second screen content, augmented content for an augmented reality device, etc. The overlays may comprise local station logos, local station tickers, advertisement banners, sign language tracks, and/or the like. If one of the local content providers 204a-n is an affiliate station, that local content provider may be configured to distribute supplemental content such as local station logos, local station tickers, and/or sign language tracks (e.g., overlays) to client devices. The sign language track be associated with the geographic region serviced by the local content provider. For example, the sign language overlay may be associated with American sign language (ASL) if the local content provider is associated with the United States, and the sign language overlay may be associated with British sign language (ASL) if the local content provider is associated with the United Kingdom, etc. If one of the local content providers 204a-n is an advertiser, that local content provider may be configured to distribute supplemental content such as advertisements to client devices.

To distribute encoded supplemental content to each of the plurality of client devices 210a-n, the plurality of local content providers 204a-n may encode the supplemental content using an encoder 208a-n. The encoders 208a-n may be configured to encode the supplemental content. The encoders 208a-n may encode a plurality of different versions of the supplemental content. Each version of the supplemental content may be encoded at a different bitrate. Each version may have other properties that differ from other versions, such as a different compression technique, compression ratio, resolution, frame rate, video quality (for video), number of channels, or sampling rate (for audio). The plurality of local content providers 204a-n may cause the encoded supplemental content, such as one or more of the plurality of different versions of the supplemental content to be sent to a requesting component, such as to each of the plurality of client devices 210a-n.

To encode the supplemental content, the encoders 208a-n may use alpha channel to express transparency in areas where there is no supplemental content. The encoder(s) 208a-n may encode a full-resolution stream. Encoding content in this manner may only work for a subset of delivery codecs (e.g., VP9 and H.265) that may not be supported by the client device hardware. Alternatively, to encode the supplemental content, the encoders 208a-n may encode the supplemental content as a video (e.g., without alpha channel) and use a defined color value to signal transparency. For example, the supplemental content may be encoded as a narrow (broadcast) range video and the defined color value may be (0,0,0). This value may be illegal for narrow range video and may be used to indicate that a macroblock or partition is considered transparent. When an overlay is written, information from pixels with a value of 0,0,0 may be discarded.

To encode the supplemental content, the encoders 208a-n may use a frame rate of the content item associated with the first manifest file. The encoder(s) 208a may omit empty P and/or B frames indicating a full copy of previous frame blocks rather than encoding them. This may facilitate synchronized stream conditioning (e.g., for advertisements) in response to supplemental content signaling (e.g., advertisement breaks), where non-empty frames may be injected whenever there is a change, such as a disappearing logo, a disappearing rating, or a switch to a different content. To encode the supplemental content, the encoders 208a-n may maintain the same delay as the content item associated with the first manifest file. For example, the encoder(s) 208a-n may encode the supplemental content with the same amount of reference frames, the same HRD parameters, and/or the same number of temporal layers as the content item associated with the first manifest file. This may maintain frame-level synchronization. To encode the supplemental content, the encoders 208a-n may maintain the same sequence parameter set (SPS), picture parameter set (PPS), and/or resolution as the content item associated with the first manifest file.

The local content provider 204a may be configured to send at least one supplemental content item and at least one supplemental manifest file corresponding to the supplemental content item(s) to the server(s) 212a. The supplemental manifest file(s) may be sent to the server(s) 212a based on (e.g., in response to) the server(s) 212a receiving the first manifest file. The supplemental manifest file(s) may each be associated with a particular supplemental content item. The supplemental content item(s) may comprise at least one overlay (e.g., graphic overlay). The overlay(s) may comprise local station logos, local station tickers, advertisement banners, sign language tracks, and/or the like. The local content provider 204a may comprise an affiliate station. If the local content provider 204a comprises an affiliate station, the supplemental content item(s) may comprise local station logos, local station tickers, and/or sign language track overlays. The local content provider 204a may comprise an advertiser. If the local content provider 204a comprises an advertiser, the supplemental content item(s) may comprise advertisement banner overlays.

The supplemental manifest file(s) may contain information describing various aspects of the supplemental content item(s) that may be useful for a user device to output (e.g., playback) the content item and/or for the local content provider 204a to store and retrieve the supplemental content item(s). For example, the supplemental manifest file(s) may indicate each of a plurality of supplemental content segments associated with the supplemental content item, the length of each segment, the number of segments, and/or the proper ordering of the segments necessary to effectuate a playback of the supplemental content item. The supplemental manifest file(s) may further indicate a network location (e.g., a hyper-text transfer protocol (HTTP) uniform resource locater (URL) link or other universal resource identifier (URI)) for each segment from which the segment may be downloaded, accessed, or retrieved. It will be appreciated that the network locations included within the supplemental manifest file may point to more than one different location or source. The supplemental manifest file(s) may further indicate available representations of the supplemental content item. A representation (e.g., also known as variant in HLS and track in CMAF) may be a single encoding version of supplemental content. As a non-limiting example, video encoded with the H.264 codec at bitrate of 4.20 Mbps, resolution of 1080p and frame rate of 59.94 fps may be a representation. Another representation may have a resolution of 780p.

The server(s) 212a may receive the first manifest file and the supplemental manifest file(s). The server(s) 212a may generate a second (e.g., modified) manifest file. The server(s) 212a may generate the second manifest file based on the first manifest file and the supplemental manifest file(s). The second manifest file may comprise data for accessing a plurality of segments of the content item and data for accessing the supplemental content item(s).

The second manifest file may comprise at least one adaptation set. Each adaptation set may be associated with a particular one of the supplemental content item(s). Generating the second manifest file may comprise determining an adaptation set associated with each of the supplemental content items. The adaptation set associated with a particular supplemental content item may be determined based on the supplemental manifest file associated with that supplemental content item. An indication of each of the adaptation set(s) may be added to the first manifest file to generate the second manifest file.

The adaptation set associated with a particular supplemental content item may indicate a transparent pixel value associated with the supplemental content item. Transparency may not be supported by some codecs. For example, transparency may not be supported by MPEG-4 advanced video coding (AVC) or by some profiles of high efficiency video coding (HEVC). If transparency is not supported, during overlay calculations, pixels with the transparent pixel value indicated by the adaptation set may be considered as transparent. A constant pixel value (e.g., 0,0,0) may be the transparent pixel value. Indicating the transparent pixel value in the adaptation set signaling may ensure proper rendering of the supplemental content item at a client device.

The adaptation set associated with a particular supplemental content item may indicate a position associated with output of the supplemental content item. The position associated with output of the supplemental content item may indicate the position (e.g., pixel position) of a top left point (e.g., coordinate) of the supplemental content item if the supplemental content item is not intended to cover the entire screen when output. For example, the position associated with output of the supplemental content item may indicate an on-screen position of a sign language track overlay or an on-screen position of a local station ticker or logo. If the supplemental content item is an advertisement overlay, the position associated with output of the supplemental content item may indicate an on-screen position as instructed by the ad decisioning server. The @canvasWidth and @canvasHeight attributes may be defined to indicate the position of the top left point of the supplemental content item. If multiple resolutions of the supplemental content item exist (e.g., for video-based overlays), the adaptation set may indicate the position of the top left point of the supplemental content item for each representation. The coordinate may be in the resolution identified by @maxHeight and @max Width attributes of the adaptation set.

The adaptation set associated with a particular supplemental content item may indicate a layer number associated with output of the supplemental content item. The layer number may be expressed as a @overlayLayer attribute. Multiple independent supplemental content items (e.g., station logo overlay and sign language track overlay) may need to be simultaneously output. If multiple supplemental content items need to be simultaneously output, the adaptation set associated with each of the multiple supplemental content items may indicate a layer number associated with output of that particular supplemental content item such that the lowest layer will be overlaid over the higher layers. The layer number may be an integer. The layer number may be unique for each adaptation set. A decoder, such as a client device, may use the layer number indicated by each of the adaptations sets to arrive at a full (e.g., flattened) overlay which may be superimposed on the content item during output of the content item. A single layer may be represented by multiple codecs (e.g., PNG, VP9, and HEVC) and/or may differ in languages (English vs. Spanish overlay language, American sign language (ASL) vs. British sign language (BSL). If a single layer is represented by multiple codecs (e.g., PNG, VP9, and HEVC) and/or differs in languages, the layer may be the same.

The adaptation set associated with a particular supplemental content item may indicate a time and/or duration associated with output of the supplemental content item. The adaptation set associated with a particular supplemental content item may indicate one or more segments of the content item during which to initiate output of the supplemental content item. The adaptation set associated with a particular supplemental content item may indicate one or more segments of the content item during which to terminate output of the supplemental content item. For example, the adaptation set associated with a particular supplemental content item may indicate that the supplemental content item is to be output for a particular duration (e.g., 15 seconds, 30 seconds, one minute, etc.) at the beginning of output of a particular content segment.

The adaptation set associated with a particular supplemental content item may indicate at least one representation associated with the supplemental content item. As described above, the supplemental manifest file(s) may indicate available representations of the supplemental content item. The adaptation set may indicate the available representations indicated by the supplemental manifest file(s).

The second manifest file may indicate that overlay support is required. The second manifest file may signal that overlay support is required in an EssentialProperty descriptor such that an unaware client device will be prevented from playing the stream. Each supplemental content adaptation set may be identified as such, such as using a new value for the Role element. If alpha channel is available, the base codec (HEVC) may be signaled along with an interoperability ISO-BMFF brand or a URN signaling a requirement for alpha channel support in the decoder.

The server(s) 212a may send the second manifest file to the client device 210a. The client device 210a may, based on the second manifest file, cause output of the supplemental content item(s) during output of at least one of the plurality of segments of the content item. The client device 210a may cause output of the supplemental content item(s) during output of the at least one of the plurality of segments of the content item by requesting the at least one of the plurality of segments of the content item from the server(s) 218 and requesting the supplemental content item(s) from the server(s) 212a. The client device 210a may request the at least one of the plurality of segments of the content item from the server(s) 218 based on the second manifest file. The client device 210a may request the supplemental content item(s) from the server(s) 212a based on the second manifest file. The client device 210a may receive the at least one of the plurality of segments of the content item from the server(s) and the supplemental content item(s).

The client device 210a may cause output of the supplemental content item(s) during output of the at least one of the plurality of segments of the content item by causing at least partially concurrent display of the at least one of the plurality of segments of the content item and the supplemental content item(s). If the supplemental content item(s) comprise an overlay, the client device 210a may cause output of the supplemental content item(s) during output of the at least one of the plurality of segments of the content item by causing the supplemental content item(s) to be overlaid on the at least one of the plurality of segments of the content item during output of the at least one of the plurality of segments of the content item. The client device 210a may decode the at least one of the plurality of segments of the content item from the server(s) and the supplemental content item(s) to cause output of the supplemental content item(s) during output of the at least one of the plurality of segments of the content item.

The local content provider 204b may be configured to send at least one supplemental content item to the server(s) 212b. The local content provider 204b may not send a supplemental manifest file corresponding to the supplemental content item(s) to the server(s) 212b. The supplemental content item(s) may be sent to the server(s) 212b based on (e.g., in response to) the server(s) 212b receiving the first manifest file. The supplemental content item(s) may comprise at least one image overlay (e.g., graphic overlay). The image overlay(s) may comprise local station logos, local station tickers, advertisement banners, and/or the like. The local content provider 204b may comprise an affiliate station. If the local content provider 204b comprises an affiliate station, the supplemental content item(s) may comprise local station logos, local station tickers, and/or sign language track overlays. The local content provider 204b may comprise an advertiser. If the local content provider 204b comprises an advertiser, the supplemental content item(s) may comprise advertisement banner overlays.

The server(s) 212b may receive the first manifest file and the supplemental content item(s). The server(s) 212b may generate a second (e.g., modified) manifest file. The server(s) 212b may generate the second manifest file based on the first manifest file and the supplemental content item(s). The second manifest file may comprise data for accessing a plurality of segments of the content item and data for accessing the supplemental content item(s). The second manifest file may comprise at least one adaptation set. Each adaptation set may be associated with a particular one of the supplemental content item(s). Generating the second manifest file may comprise determining an adaptation set associated with each of the supplemental content items and adding an indication of the adaption set(s) to the first manifest file.

The adaptation set associated with a particular supplemental content item may indicate a transparent pixel value associated with the supplemental content item. Transparency may not be supported by some codecs. For example, transparency may not be supported by MPEG-4 advanced video coding (AVC) or by some profiles of high efficiency video coding (HEVC). If transparency is not supported, during overlay calculations, pixels with the transparent pixel value indicated by the adaptation set may be considered as transparent. A constant pixel value (e.g., 0,0,0) may be the transparent pixel value. Indicating the transparent pixel value in the adaptation set signaling may ensure proper rendering of the supplemental content item at a client device.

The adaptation set associated with a particular supplemental content item may indicate a position associated with output of the supplemental content item. The position associated with output of the supplemental content item may indicate the position (e.g., pixel position) of a top left point (e.g., coordinate) of the supplemental content item if the supplemental content item is not intended to cover the entire screen when output. For example, the position associated with output of the supplemental content item may indicate an on-screen position of a sign language track overlay or an on-screen position of a local station ticker or logo. If the supplemental content item is an advertisement overlay, the position associated with output of the supplemental content item may indicate an on-screen position as instructed by the ad decisioning server. The @canvasWidth and @canvasHeight attributes may be defined to indicate the position of the top left point of the supplemental content item. If multiple resolutions of the supplemental content item exist (e.g., for video-based overlays), the adaptation set may indicate the position of the top left point of the supplemental content item for each representation. The coordinate may be in the resolution identified by @maxHeight and @max Width attributes of the adaptation set.

The adaptation set associated with a particular supplemental content item may indicate a layer number associated with output of the supplemental content item. The layer number may be expressed as a @overlayLayer attribute. Multiple independent supplemental content items (e.g., station logo overlay and sign language track overlay) may need to be simultaneously output. If multiple supplemental content items need to be simultaneously output, the adaptation set associated with each of the multiple supplemental content items may indicate a layer number associated with output of that particular supplemental content item such that the lowest layer will be overlaid over the higher layers. The layer number may be an integer. The layer number may be unique for each adaptation set. A decoder, such as at a client device, may use the layer number indicated by each of the adaptations sets to arrive at a full (e.g., flattened) overlay which may be superimposed on the content item during output of the content item. A single layer may be represented by multiple codecs (e.g., PNG, VP9, and HEVC) and/or may differ in languages (English vs. Spanish overlay language, American sign language (ASL) vs. British sign language (BSL). If a single layer is represented by multiple codecs (e.g., PNG, VP9, and HEVC) and/or differs in languages, the layer may be the same.

The adaptation set associated with a particular supplemental content item may indicate a time and/or duration associated with output of the supplemental content item. The adaptation set associated with a particular supplemental content item may indicate one or more segments of the content item during which to initiate output of the supplemental content item. The adaptation set associated with a particular supplemental content item may indicate one or more segments of the content item during which to terminate output of the supplemental content item. For example, the adaptation set associated with a particular supplemental content item may indicate that the supplemental content item is to be output for a particular duration (e.g., 15 seconds, 30 seconds, one minute, etc.) at the beginning of output of a particular content segment.

The adaptation set associated with a particular supplemental content item may indicate at least one representation associated with the supplemental content item. As described above, the supplemental manifest file(s) may indicate available representations of the supplemental content item. The adaptation set may indicate the available representations indicated by the supplemental manifest file(s).

The server(s) 212b may send the second manifest file to the client device 210b. The client device 210b may, based on the second manifest file, cause output of the supplemental content item(s) during output of at least one of the plurality of segments of the content item. The client device 210b may cause output of the supplemental content item(s) during output of the at least one of the plurality of segments of the content item by requesting the at least one of the plurality of segments of the content item from the server(s) 218 and requesting the supplemental content item(s) from the server(s) 212b. The client device 210b may request the at least one of the plurality of segments of the content item from the server(s) 218 based on the second manifest file. The client device 210b may request the supplemental content item(s) from the server(s) 212b based on the second manifest file. The client device 210b may receive the at least one of the plurality of segments of the content item from the server(s) and the supplemental content item(s).

The client device 210b may cause output of the supplemental content item(s) during output of the at least one of the plurality of segments of the content item by causing at least partially concurrent display of the at least one of the plurality of segments of the content item and the supplemental content item(s). If the supplemental content item(s) comprise an overlay, the client device 210b may cause output of the supplemental content item(s) during output of the at least one of the plurality of segments of the content item by causing the supplemental content item(s) to be overlaid on the at least one of the plurality of segments of the content item during output of the at least one of the plurality of segments of the content item. The client device 210b may decode the at least one of the plurality of segments of the content item from the server(s) and the supplemental content item(s) to cause output of the supplemental content item(s) during output of the at least one of the plurality of segments of the content item.

The local content provider 204n may be configured to send at least one supplemental content item and at least one supplemental manifest file corresponding to the supplemental content item(s) to the server(s) 212n. The supplemental manifest file(s) may be sent to the server(s) 212n based on (e.g., in response to) the server(s) 212n receiving the first manifest file. The supplemental manifest file(s) may each be associated with a particular supplemental content item. The supplemental content item(s) may comprise at least one overlay (e.g., graphic overlay). The overlay(s) may comprise local station logos, local station tickers, advertisement banners, sign language tracks, and/or the like. The local content provider 204n may comprise an affiliate station. If the local content provider 204n comprises an affiliate station, the supplemental content item(s) may comprise local station logos, local station tickers, and/or sign language track overlays. The local content provider 204n may comprise an advertiser. If the local content provider 204n comprises an advertiser, the supplemental content item(s) may comprise advertisement banner overlays.

The supplemental manifest file(s) may contain information describing various aspects of the supplemental content item(s) that may be useful for a user device to output (e.g., playback) the content item and/or for the local content provider 204a to store and retrieve the supplemental content item(s). For example, the supplemental manifest file(s) may indicate each of a plurality of supplemental content segments associated with the supplemental content item, the length of each segment, the number of segments, and/or the proper ordering of the segments necessary to effectuate a playback of the supplemental content item. The supplemental manifest file(s) may further indicate a network location (e.g., a hyper-text transfer protocol (HTTP) uniform resource locater (URL) link or other universal resource identifier (URI)) for each segment from which the segment may be downloaded, accessed, or retrieved. It will be appreciated that the network locations included within the supplemental manifest file may point to more than one different location or source. The supplemental manifest file(s) may further indicate available representations of the supplemental content item. A representation (e.g., also known as variant in HLS and track in CMAF) may be a single encoding version of supplemental content. As a non-limiting example, video encoded with the H.264 codec at bitrate of 4.20 Mbps, resolution of 1080p and frame rate of 59.94 fps may be a representation. Another representation may have a resolution of 780p.

The server(s) 212n may send the supplemental content item(s) and the supplemental manifest file(s) to the server 220. The server 220 may receive the first manifest file, the supplemental manifest file(s), and the supplemental content item(s). The server 220 may generate a second (e.g., modified) manifest file. The server 220 may generate the second manifest file based on the first manifest file and the supplemental manifest file(s). The second manifest file may comprise data for accessing a plurality of segments of the content item and data for accessing the supplemental content item(s).

The second manifest file may comprise at least one adaptation set. Each adaptation set may be associated with a particular one of the supplemental content item(s). Generating the second manifest file may comprise determining an adaptation set associated with each of the supplemental content items. The adaptation set associated with a particular supplemental content item may be determined based on the supplemental manifest file associated with that supplemental content item. An indication of each of the adaptation set(s) may be added to the first manifest file to generate the second manifest file.

The adaptation set associated with a particular supplemental content item may indicate a transparent pixel value associated with the supplemental content item. Transparency may not be supported by some codecs. For example, transparency may not be supported by MPEG-4 advanced video coding (AVC) or by some profiles of high efficiency video coding (HEVC). If transparency is not supported, during overlay calculations, pixels with the transparent pixel value indicated by the adaptation set may be considered as transparent. A constant pixel value (e.g., 0,0,0) may be the transparent pixel value. Indicating the transparent pixel value in the adaptation set signaling may ensure proper rendering of the supplemental content item at a client device.

The adaptation set associated with a particular supplemental content item may indicate a position associated with output of the supplemental content item. The position associated with output of the supplemental content item may indicate the position (e.g., pixel position) of a top left point (e.g., coordinate) of the supplemental content item if the supplemental content item is not intended to cover the entire screen when output. For example, the position associated with output of the supplemental content item may indicate an on-screen position of a sign language track overlay or an on-screen position of a local station ticker or logo. If the supplemental content item is an advertisement overlay, the position associated with output of the supplemental content item may indicate an on-screen position as instructed by the ad decisioning server. The @canvasWidth and @canvasHeight attributes may be defined to indicate the position of the top left point of the supplemental content item. If multiple resolutions of the supplemental content item exist (e.g., for video-based overlays), the adaptation set may indicate the position of the top left point of the supplemental content item for each representation. The coordinate may be in the resolution identified by @maxHeight and @max Width attributes of the adaptation set.

The adaptation set associated with a particular supplemental content item may indicate a layer number associated with output of the supplemental content item. The layer number may be expressed as a @overlayLayer attribute. Multiple independent supplemental content items (e.g., station logo overlay and sign language track overlay) may need to be simultaneously output. If multiple supplemental content items need to be simultaneously output, the adaptation set associated with each of the multiple supplemental content items may indicate a layer number associated with output of that particular supplemental content item such that the lowest layer will be overlaid over the higher layers. The layer number may be an integer. The layer number may be unique for each adaptation set. A decoder, such as a client device, may use the layer number indicated by each of the adaptations sets to arrive at a full (e.g., flattened) overlay which may be superimposed on the content item during output of the content item. A single layer may be represented by multiple codecs (e.g., PNG, VP9, and HEVC) and/or may differ in languages (English vs. Spanish overlay language, American sign language (ASL) vs. British sign language (BSL). If a single layer is represented by multiple codecs (e.g., PNG, VP9, and HEVC) and/or differs in languages, the layer may be the same.

The adaptation set associated with a particular supplemental content item may indicate a time and/or duration associated with output of the supplemental content item. The adaptation set associated with a particular supplemental content item may indicate one or more segments of the content item during which to initiate output of the supplemental content item. The adaptation set associated with a particular supplemental content item may indicate one or more segments of the content item during which to terminate output of the supplemental content item. For example, the adaptation set associated with a particular supplemental content item may indicate that the supplemental content item is to be output for a particular duration (e.g., 15 seconds, 30 seconds, one minute, etc.) at the beginning of output of a particular content segment.

The adaptation set associated with a particular supplemental content item may indicate at least one representation associated with the supplemental content item. As described above, the supplemental manifest file(s) may indicate available representations of the supplemental content item. The adaptation set may indicate the available representations indicated by the supplemental manifest file(s).

The second manifest file may indicate that overlay support is required. The second manifest file may signal that overlay support is required in an EssentialProperty descriptor such that an unaware client device will be prevented from playing the stream. Each supplemental content adaptation set may be identified as such, such as using a new value for the Role element. If alpha channel is available, the base codec (HEVC) may be signaled along with an interoperability ISO-BMFF brand or a URN signaling a requirement for alpha channel support in the decoder.

The server 220 may send the second manifest file to the client device 210n. The client device 210n may, based on the second manifest file, cause output of the supplemental content item(s) during output of at least one of the plurality of segments of the content item. The client device 210n may cause output of the supplemental content item(s) during output of the at least one of the plurality of segments of the content item by requesting the at least one of the plurality of segments of the content item from the server(s) 218 and requesting the supplemental content item(s) from the server(s) 220. The client device 210n may request the at least one of the plurality of segments of the content item from the server(s) 218 based on the second manifest file. The client device 210n may request the supplemental content item(s) from the server(s) 220 based on the second manifest file. The client device 210n may receive the at least one of the plurality of segments of the content item and the supplemental content item(s).

The client device 210n may cause output of the supplemental content item(s) during output of the at least one of the plurality of segments of the content item by causing at least partially concurrent display of the at least one of the plurality of segments of the content item and the supplemental content item(s). If the supplemental content item(s) comprise an overlay, the client device 210n may cause output of the supplemental content item(s) during output of the at least one of the plurality of segments of the content item by causing the supplemental content item(s) to be overlaid on the at least one of the plurality of segments of the content item during output of the at least one of the plurality of segments of the content item. The client device 210n may decode the at least one of the plurality of segments of the content item from the server(s) and the supplemental content item(s) to cause output of the supplemental content item(s) during output of the at least one of the plurality of segments of the content item.

The plurality of client devices 210a-n may comprise a television, a monitor, a laptop, a desktop, a smart phone, a set-top box, a cable modem, a gateway, a tablet, a wearable computing device, a mobile computing device, any computing device configured to receive and/or output (e.g., playback, display) content, and/or any combination of the foregoing. It should be noted that while the singular term device is used herein, it is contemplated that some devices may be implemented as a single device or a plurality of devices (e.g., via load balancing). Any device disclosed herein may be implemented using one or more computing nodes, such as virtual machines, executed on a single device and/or multiple devices.

As an alternative to sending a single manifest file (e.g., the second manifest file) to the client devices 210a-n for output both the supplemental content and the main content, one or more events (e.g., DASH event) associated with one or more supplemental content items may be embedded into the first manifest file. The event(s) associated with one or more supplemental content items may be embedded into the first manifest file, for example, by the server(s) 212a-n and/or by the server 220.

Each event may be associated with a particular supplemental content item. The event associated with a particular supplemental content item may contain the supplemental manifest file associated with that supplemental content item, a playlist associated with that supplemental content item, and/or a location (e.g., image URL, DASH MPD URL, HLS m3u8 URL) associated with that supplemental content item. The event associated with a particular supplemental content item may comprise a data URI inlining the supplemental content item (e.g., image) or supplemental manifest. The data URI may inline the supplemental content item or supplemental manifest in a compressed state (e.g., the supplemental content item may be compressed with gzip or brotli, and then base64-coded into a URL). The event associated with a particular supplemental content item may indicate a start time and duration for output of that supplemental content item, a position (e.g., pixel position) associated with output of the supplemental content item and/or a media (e.g., MIME, content) type of the supplemental content item. The media type may indicate a media type of the expected response to a GET request to a media URL or data URL. Based on the content of an event associated with a particular supplemental content item, the supplemental content item may be received as a DASH MPD event (e.g., event XML element in the DASH MPD), as a HLS EXT-X-DATERANGE tag in an m3u8 playlist, and/or in an ‘emsg’ box in a media segment. Further, an event may be carried in a supplemental manifest or segment, triggering output of yet another supplemental content item (e.g., another layer of overlays overlaid over the current overlay).

The client devices 210a-n may receive the first manifest file with the embedded event(s). The client devices may each comprise a first client player and a second client player. The first client player may cause output of the content item (e.g., the main content item). The second client player may cause output of the supplemental content item(s). A termination event may be inserted into the first manifest file. The second client player may process the event(s) embedded in the first manifest file. The second client player may terminate output of the supplemental content item(s) based on the termination event and/or by terminating output of the supplemental content item(s) programmatically. The first client player may receive the termination event and generate a representation termination event. The representation termination event may instruct the second client player to terminate output of the supplemental content item at a certain time. The first client player may send the representation termination event to the second client player. The second client player may receive the representation termination event. Based on receiving the representation termination event, the second client player may terminate output of the supplemental content item at the certain time. The second client player may subscribe to these representation termination events.

Additionally or alternatively, the first client player may cause output of the content item (e.g., the main content item). The second client player may cause output of the supplemental content item(s). The server(s) 212a-n and/or the server 220 may modify the supplemental manifest file(s) associated with the supplemental content item(s). The server(s) 212a-n and/or the server 220 may modify the supplemental manifest file(s) to indicate that output of the supplemental content item(s) should terminate at a certain time. The second client player may, based on the modified supplemental manifest file(s), terminate output of the supplemental content item(s) at the certain time.

The supplemental content item may comprise a static image (e.g., logo, banner, etc.). During output, the static image may be configured to fade-in at output start time and fade-out at output termination time. To facilitate this fade-in and fade-out of a static image, three periods may be created in the supplemental manifest file associated with the static image. The first period may contain one or more video segments encoding a fade in. The second period may contain the static image or video-coded static image (e.g., a single-IDR video segment) or an image file (e.g., a PNG file) associated with the static image. The third period may contain the fade-out effect as a video. The third period may be inserted into the supplemental manifest file by the server(s) 212a-n and/or the server 220 when the server(s) 212a-n and/or the server 220 modifies the supplemental manifest file to indicate that output of the supplemental content item(s) should terminate at a certain time.

Additionally or alternatively, to facilitate this fade-in and fade-out of a static image, a single period may be created in the supplemental manifest file. The single period may contain three SegmentTemplate elements. Non-templated URLs may be contained in the three SegmentTemplate elements. The server(s) 212a-n and/or the server 220 may insert the last element when the server(s) 212a-n and/or the server 220 modifies the supplemental manifest file to indicate that output of the supplemental content item(s) should terminate at a certain time.

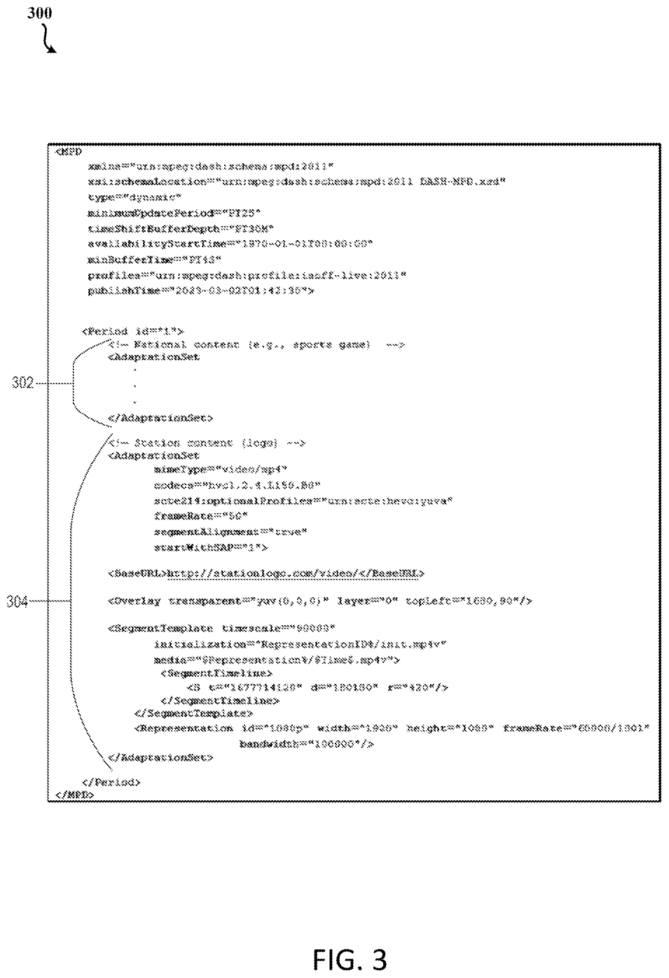

FIG. 3 is an example portion of a manifest file 300. The manifest file 300 may comprise first data 302. The first data 302 may be used for accessing a plurality of segments of a content item (e.g., main content item). The first data 302 may contain information describing various aspects of the content item that may be useful for a user device to output (e.g., playback) the content item and/or for the content provider to store and retrieve the content item. For example, the first data 302 may indicate each of a plurality of content segments associated with the content item, the length of each segment, the number of segments, and/or the proper ordering of the segments necessary to effectuate a playback of the content item. The first data 302 may further indicate a network location (e.g., a hyper-text transfer protocol (HTTP) uniform resource locater (URL) link or other universal resource identifier (URI)) for each segment from which the segment may be downloaded, accessed, or retrieved. It will be appreciated that the network locations included within the first manifest file may point to more than one different location or source. The first data 302 may further indicate available representations of the content item. A representation (e.g., also known as variant in HLS and track in CMAF) may be a single encoding version of content. As a non-limiting example, video encoded with the H.264 codec at bitrate of 4.20 Mbps, resolution of 1080p and frame rate of 59.94 fps may be a representation. Another representation may have a resolution of 780p.

The manifest file 300 may comprise second data 304. The second data 304 may be used for accessing a supplemental content item. The supplemental content item may comprise at least one of a station logo overlay, a station ticker overlay, an advertisement banner overlay, or a sign language track overlay. The second data 304 may comprise an adaptation set. The adaptation set may be associated with the supplemental content item. The adaptation set associated with the supplemental content item may indicate at least one of a transparent pixel value associated with the supplemental content item, a position associated with output of the supplemental content item, a layer number associated with output of the supplemental content item, a time associated with output of the supplemental content item, a duration associated with output of the supplemental content item, and at least one representation associated with the supplemental content item.

A client device may receive the manifest file 300. Based on the manifest file 300, the client device may request at least one segment of the content item based on the first data 302 and request the supplemental content item based on the second data 304. The client device may cause output of the supplemental content item during output of the segment(s) of the content item by causing at least partially concurrent display of the segment(s) of the content item and the supplemental content item. If the supplemental content item comprises an overlay, the client device may cause output of the supplemental content item during output of the segment(s) of the content item by causing the supplemental content item to be overlaid on the segment(s) of the content item during output of the segment(s) of the content item.

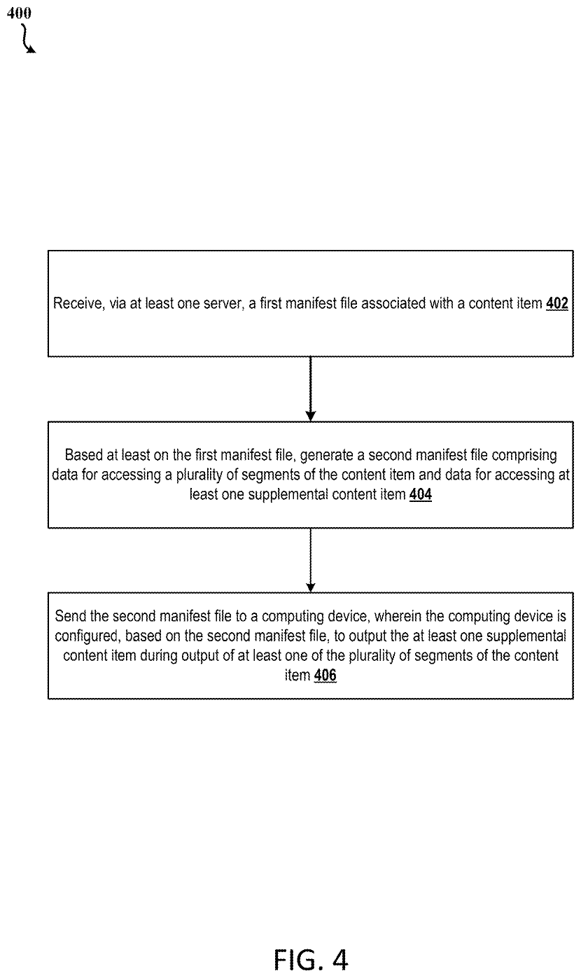

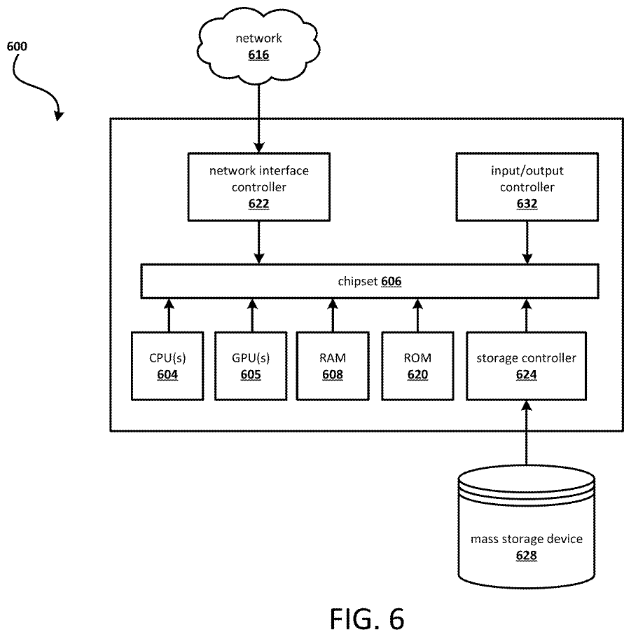

FIG. 4 is a flow diagram illustrating an example method 400. The method 400 may comprise a computer implemented method for distributing supplemental content. A system and/or computing environment, such as the system 200 of FIG. 2 and/or the computing environment of FIG. 6, may be configured to perform the method 400. For example, one or more of the servers 212a-b or the server 220 of FIG. 2 may be configured to perform the method 400.

At 402, a first manifest file may be received. The first manifest file may be received via at least one server. The at least one server may be associated with an affiliate of a content network. The at least one server may be associated with an advertiser. For example, the at least one server may comprise an ad decisioning server. The first manifest file may be associated with a content item (e.g., main content item). The first manifest file may contain information describing various aspects of the content item that may be useful for a user device to output (e.g., playback) the content item and/or for a content provider to store and retrieve the content item.

For example, the first manifest file may indicate each of a plurality of content segments associated with the content item, the length of each segment, the number of segments, and/or the proper ordering of the segments necessary to effectuate a playback of the content item. The first manifest file may further indicate a network location (e.g., a hyper-text transfer protocol (HTTP) uniform resource locater (URL) link or other universal resource identifier (URI)) for each segment from which the segment may be downloaded, accessed, or retrieved. It will be appreciated that the network locations included within the first manifest file may point to more than one different location or source. The first manifest file may further indicate available representations of the content item. A representation (e.g., also known as variant in HLS and track in CMAF) may be a single encoding version of content. As a non-limiting example, video encoded with the H.264 codec at bitrate of 4.20 Mbps, resolution of 1080p and frame rate of 59.94 fps may be a representation. Another representation may have a resolution of 780p.

At 406, a second manifest file may be generated. The second manifest file may be generated based at least on the first manifest file. The second manifest file may comprise data for accessing a plurality of segments of the content item. The second manifest file may comprise data for accessing at least one supplemental content item. The at least one supplemental content item may comprise at least one of a station logo overlay, a station ticker overlay, an advertisement banner overlay, or a sign language track overlay.

The second manifest file may comprise at least one adaptation set. Each adaptation set may be associated with one of the at least one supplemental content items. Generating the second manifest file may comprise determining an adaptation set associated with each of the at least one supplemental content items. The adaptation set associated with a supplemental content item may be determined based on a supplemental manifest file associated with the supplemental content item. An indication of each adaptation set may be added to the first manifest file to generate the second manifest file. The adaptation set associated with a supplemental content item may indicate at least one of a transparent pixel value associated with the supplemental content item, a position associated with output of the supplemental content item, a layer number associated with output of the supplemental content item, a time associated with output of the supplemental content item, a duration associated with output of the supplemental content item, and at least one representation associated with the supplemental content item.

At 408, the second manifest file may be sent to a computing device (e.g., client device). The computing device may be configured to output the at least one supplemental content item during output of at least one of the plurality of segments of the content item. The computing device may be configured to output the at least one supplemental content item during output of at least one of the plurality of segments of the content item based on the second manifest file. The computing device may be configured to output the at least one supplemental content item during output of the at least one of the plurality of segments of the content item by causing at least partially concurrent display of the at least one of the plurality of segments of the content item and the at least one supplemental content item. If the at least one supplemental content item comprises an overlay, the computing device may be configured to output the at least one supplemental content item during output of the at least one of the plurality of segments of the content item by causing the at least one supplemental content item to be overlaid on the at least one of the plurality of segments of the content item during output of the at least one of the plurality of segments of the content item. The computing device may be configured to output the at least one supplemental content item during output of the at least one of the plurality of segments of the content item by requesting the at least one of the plurality of segments of the content item from a server associated with a content network (e.g., content provider 202) and requesting the supplemental content item from the least one server.

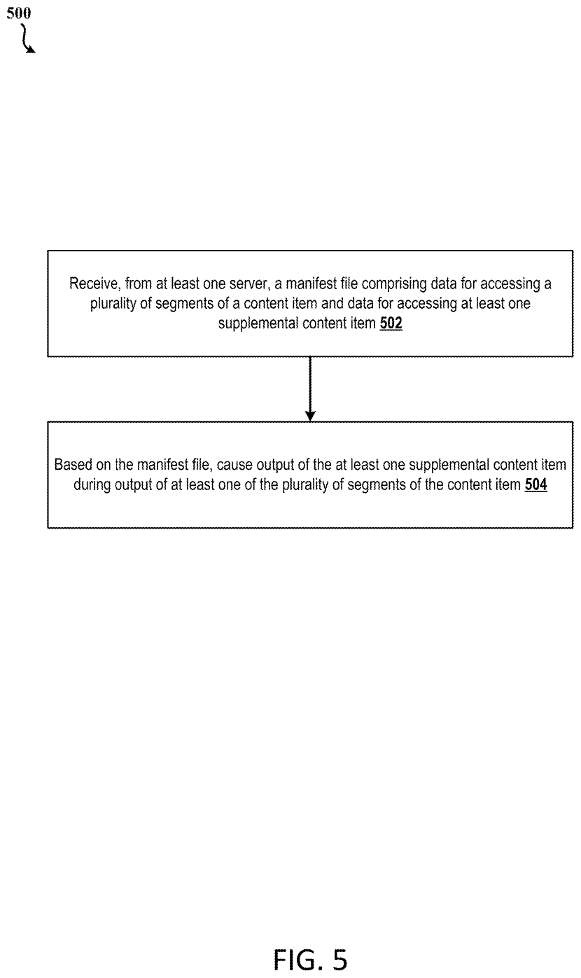

FIG. 5 is a flow diagram illustrating an example method 500. The method 500 may comprise a computer implemented method for distributing supplemental content. A system and/or computing environment, such as the system 200 of FIG. 2 and/or the computing environment of FIG. 6, may be configured to perform the method 500. For example, one or more of the client devices 210a-n FIG. 2 may be configured to perform the method 500.

At 502, a manifest file may be received from at least one server. The manifest file may be received at a computing device (e.g., client device 210a-n). The manifest file may comprise data for accessing a plurality of segments of a content item. The manifest file may comprise data for accessing at least one supplemental content item. The at least one supplemental content item may comprise at least one of a station logo overlay, a station ticker overlay, an advertisement banner overlay, or a sign language track overlay. The manifest file may comprise at least one adaptation set. Each of the at least one adaptation sets may be associated with one of the at least one supplemental content items. The adaptation set associated with a supplemental content item may indicate at least one of a transparent pixel value associated with the supplemental content item, a position associated with output of the supplemental content item, a layer number associated with output of the supplemental content item, a time associated with output of the supplemental content item, a duration associated with output of the supplemental content item, and at least one representation associated with the supplemental content item.

At 504, output of the at least one supplemental content item during output of at least one of the plurality of segments of the content item may be caused. The output of the at least one supplemental content item during output of at least one of the plurality of segments of the content item may be caused based on the manifest file. Outputting the at least one supplemental content item during output of the at least one of the plurality of segments of the content item may comprise causing at least partially concurrent display of the at least one of the plurality of segments of the content item and the at least one supplemental content item. If the at least one supplemental content item comprises an overlay, causing output of the at least one supplemental content item during output of the at least one of the plurality of segments of the content item may comprise causing the at least one supplemental content item to be overlaid on the at least one of the plurality of segments of the content item during output of the at least one of the plurality of segments of the content item. Causing output of the at least one supplemental content item during output of the at least one of the plurality of segments of the content item may comprise requesting the at least one of the plurality of segments of the content item from a server associated with a content network (e.g., content provider 202) and requesting the at least one supplemental content item from the least one server.

FIG. 6 depicts a computing device that may be used in various aspects, such as any of the servers, devices, content providers, and/or local content providers depicted in FIG. 1 and/or FIG. 2. With regard to the example architecture of FIG. 1 and FIG. 2, any of the servers, devices, content providers, and/or local content providers may each be implemented in an instance of a computing device 600 of FIG. 6.

The computer architecture shown in FIG. 6 shows a conventional server computer, workstation, desktop computer, laptop, tablet, network appliance, PDA, e-reader, digital cellular phone, or other computing node, and may be utilized to execute any aspects of the computers described herein, such as to implement the methods described in relation to FIG. 4 and FIG. 5.

The computing device 600 may include a baseboard, or “motherboard,” which is a printed circuit board to which a multitude of components or devices may be connected by way of a system bus or other electrical communication paths. One or more central processing units (CPUs) 604 may operate in conjunction with a chipset 606. The CPU(s) 604 may be standard programmable processors that perform arithmetic and logical operations necessary for the operation of the computing device 600.

The CPU(s) 604 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 604 may be augmented with or replaced by other processing units, such as GPU(s) 605. The GPU(s) 605 may comprise processing units specialized for but not necessarily limited to highly parallel computations, such as graphics and other visualization-related processing.

A chipset 606 may provide an interface between the CPU(s) 604 and the remainder of the components and devices on the baseboard. The chipset 606 may provide an interface to a random access memory (RAM) 608 used as the main memory in the computing device 600. The chipset 606 may further provide an interface to a computer-readable storage medium, such as a read-only memory (ROM) 620 or non-volatile RAM (NVRAM) (not shown), for storing basic routines that may help to start up the computing device 600 and to transfer information between the various components and devices. ROM 620 or NVRAM may also store other software components necessary for the operation of the computing device 600 in accordance with the aspects described herein.

The computing device 600 may operate in a networked environment using logical connections to remote computing nodes and computer systems through local area network (LAN) 616. The chipset 606 may include functionality for providing network connectivity through a network interface controller (NIC) 622, such as a gigabit Ethernet adapter. A NIC 622 may be capable of connecting the computing device 600 to other computing nodes over a network 616. It should be appreciated that multiple NICs 622 may be present in the computing device 600, connecting the computing device to other types of networks and remote computer systems.

The computing device 600 may be connected to a mass storage device 628 that provides non-volatile storage for the computer. The mass storage device 628 may store system programs, application programs, other program modules, and data, which have been described in greater detail herein. The mass storage device 628 may be connected to the computing device 600 through a storage controller 624 connected to the chipset 606. The mass storage device 628 may consist of one or more physical storage units. A storage controller 624 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 600 may store data on a mass storage device 628 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 628 is characterized as primary or secondary storage and the like.

For example, the computing device 600 may store information to the mass storage device 628 by issuing instructions through a storage controller 624 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 600 may further read information from the mass storage device 628 by detecting the physical states or characteristics of one or more particular locations within the physical storage units.

In addition to the mass storage device 628 described above, the computing device 600 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 600.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 628 depicted in FIG. 6, may store an operating system utilized to control the operation of the computing device 600. The operating system may comprise a version of the LINUX operating system. The operating system may comprise a version of the WINDOWS SERVER operating system from the MICROSOFT Corporation. According to further aspects, the operating system may comprise a version of the UNIX operating system. Various mobile phone operating systems, such as IOS and ANDROID, may also be utilized. It should be appreciated that other operating systems may also be utilized. The mass storage device 628 may store other system or application programs and data utilized by the computing device 600.

The mass storage device 628 or other computer-readable storage media may also be encoded with computer-executable instructions, which, when loaded into the computing device 600, transforms the computing device from a general-purpose computing system into a special-purpose computer capable of implementing the aspects described herein. These computer-executable instructions transform the computing device 600 by specifying how the CPU(s) 604 transition between states, as described above. The computing device 600 may have access to computer-readable storage media storing computer-executable instructions, which, when executed by the computing device 600, may perform the methods described in relation to FIG. 4 and FIG. 5.

A computing device, such as the computing device 600 depicted in FIG. 6, may also include an input/output controller 632 for receiving and processing input from a number of input devices, such as a keyboard, a mouse, a touchpad, a touch screen, an electronic stylus, or other type of input device. Similarly, an input/output controller 632 may provide output to a display, such as a computer monitor, a flat-panel display, a digital projector, a printer, a plotter, or other type of output device. It will be appreciated that the computing device 600 may not include all of the components shown in FIG. 6, may include other components that are not explicitly shown in FIG. 6, or may utilize an architecture completely different than that shown in FIG. 6.

As described herein, a computing device may be a physical computing device, such as the computing device 600 of FIG. 6. A computing node may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described herein with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described above may be used independently of one another, or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, or in addition, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed is:

1. A method comprising:
receiving, via at least one server, a first manifest file associated with a content item;
based at least on the first manifest file, generating a second manifest file comprising data for accessing a plurality of segments of the content item and data for accessing at least one supplemental content item; and
sending the second manifest file to a computing device, wherein the computing device is configured, based on the second manifest file, to output the at least one supplemental content item during output of at least one of the plurality of segments of the content item.

2. The method of claim 1, wherein the second manifest file comprises an adaptation set indicating the data for accessing the at least one supplemental content item.

3. The method of claim 1, wherein the second manifest file comprises an adaptation set associated with the at least one supplemental content item, and wherein the adaptation set associated with the at least one supplemental content item indicates at least one of:
a transparent pixel value associated with the at least one supplemental content item;
a position associated with output of the at least one supplemental content item;
a layer number associated with output of the at least one supplemental content item;
a time associated with output of the at least one supplemental content item;
a duration associated with output of the at least one supplemental content item; and
at least one representation associated with the at least one supplemental content item.

4. The method of claim 1, wherein generating the second manifest file comprises:
determining at least one adaptation set associated with the at least one supplemental content item; and
adding an indication of the at least one adaptation set associated with the at least one supplemental content item to the first manifest file.

5. The method of claim 1, further comprising receiving, via the at least one server, at least one supplemental manifest file associated with the at least one supplemental content item, and wherein generating the second manifest file is further based on the at least one supplemental manifest file.

6. The method of claim 1, wherein the computing device is configured to output the at least one supplemental content item during output of the at least one of the plurality of segments of the content item by causing at least partially concurrent display of the at least one of the plurality of segments of the content item and the at least one supplemental content item.

7. The method of claim 1, wherein the at least one supplemental content item comprises an overlay, and wherein the computing device is configured to output the at least one supplemental content item during output of the at least one of the plurality of segments of the content item by causing the at least one supplemental content item to be overlaid on the at least one of the plurality of segments of the content item during output of the at least one of the plurality of segments of the content item.

8. The method of claim 1, wherein the computing device is configured to output the at least one supplemental content item during output of the at least one of the plurality of segments of the content item by requesting the at least one of the plurality of segments of the content item from a server associated with a content network and requesting the at least one supplemental content item from the least one server.

9. The method of claim 1, wherein at least one virtualized cable modem termination system (vCMTS) is executing on the at least one server.

10. The method of claim 1, wherein the at least one server is associated with an affiliate of a content network or an advertiser.

11. The method of claim 1, wherein the at least one supplemental content item comprises at least one of a station logo overlay, a station ticker overlay, an advertisement banner overlay, or a sign language track overlay.

12. A device comprising:
one or more processors; and
memory storing instructions that, when executed by the one or more processors, cause the device to:
receive, via at least one server, a first manifest file associated with a content item;
based at least on the first manifest file, generate a second manifest file comprising data for accessing a plurality of segments of the content item and data for accessing at least one supplemental content item; and
send the second manifest file to a computing device, wherein the computing device is configured, based on the second manifest file, to output the at least one supplemental content item during output of at least one of the plurality of segments of the content item.

13. The device of claim 12, wherein the second manifest file comprises an adaptation set indicating the data for accessing the at least one supplemental content item.

14. The device of claim 12, wherein the memory storing instructions that, when executed by the one or more processors, cause the device to generate the second manifest file cause the device to:
determine at least one adaptation set associated with the at least one supplemental content item; and
add an indication of the at least one adaptation set associated with the at least one supplemental content item to the first manifest file.

15. The device of claim 12, wherein the memory storing instructions that, when executed by the one or more processors, further cause the device to receive, via the at least one server, at least one supplemental manifest file associated with the at least one supplemental content item, and wherein generating the second manifest file is further based on the at least one supplemental manifest file.

16. The device of claim 12, wherein the computing device is configured to output the at least one supplemental content item during output of the at least one of the plurality of segments of the content item by causing at least partially concurrent display of the at least one of the plurality of segments of the content item and the at least one supplemental content item.

17. A computer-readable medium storing instructions that, when executed, cause:
receiving, via at least one server, a first manifest file associated with a content item;
based at least on the first manifest file, generating a second manifest file comprising data for accessing a plurality of segments of the content item and data for accessing at least one supplemental content item; and
sending the second manifest file to a computing device, wherein the computing device is configured, based on the second manifest file, to output the at least one supplemental content item during output of at least one of the plurality of segments of the content item.

18. The computer-readable medium of claim 17, wherein the second manifest file comprises an adaptation set indicating the data for accessing the at least one supplemental content item.

19. The computer-readable medium of claim 17, wherein generating the second manifest file comprises:
determining at least one adaptation set associated with the at least one supplemental content item; and
adding an indication of the at least one adaptation set associated with the at least one supplemental content item to the first manifest file.

20. The computer-readable medium of claim 17, wherein the computing device is configured to output the at least one supplemental content item during output of the at least one of the plurality of segments of the content item by causing at least partially concurrent display of the at least one of the plurality of segments of the content item and the at least one supplemental content item.
